(19) United States
(12) Patent Application Publication
(10) Pub. No.: US 2019/0135048 A1
(43) Pub. Date: May 9, 2019

(54) TIRE WEAR INDICATOR

(71) Applicant: Bridgestone Americas Tire Operations, LLC, Nashville, TN (US)

(72) Inventor: Thaddeus T. Thompson, Massillon, OH (US)

(21) Appl. No.: 16/096,173

(22) PCT Filed: Apr. 11, 2017
(86) PCT No.: PCT/US2017/026886

§ 371 Date: Oct. 24, 2018

Related U.S. Application Data
(60) Provisional application No. 62/339,168, filed on May 20, 2016.

(51) Int. Cl. B60C 11/24; B60C 11/13

(52) U.S. Cl. CPC B60C 11/24; B60C 2011/1338; B60C 11/1307

(57) ABSTRACT

Various embodiments of a tire wear indicator are provided. In one embodiment, a tire having a tread is provided, comprising: a ground-contacting portion oriented at the radially outermost surface of the tire; at least one notch extending radially inward from the ground-contacting portion, wherein the at least one notch includes at least one notch sidewall and a notch base; at least one tire wear indicator extending from the at least one notch sidewall partially into the at least one notch; wherein the at least one tire wear indicator does not extend completely across the at least one notch; and wherein the at least one tire wear indicator does not directly contact the notch base.

### BACKGROUND

Vehicle tires include a ground-contacting portion typically oriented at a radially-outermost surface. The ground-contacting portion is that portion of the tire that engages a running surface, which may be any of a variety of surfaces, including a roadway, floor, turf, soil, and the like. The ground-contacting portion of the tire tends to wear away with use of the tire; ground-contacting portion wear is often a key factor in determining the service life remaining in a tire while maintaining its safe operation.

Many vehicle tires experience uneven wear during the service life of the tire. As a simplified example, a ground-contacting portion may be divided into three sections, including for example an outboard section, a central section, and an inboard section (it is understood that a ground-contacting portion may experience wear differential in any number of “sections”). During its service life, a tire may experience more or less wear in any of the aforementioned sections. For example, an outboard section of the ground-contacting portion may wear more than an inboard section, and either the outboard section or the inboard section may wear more or less than a central section. A variety of factors may cause uneven wear in a tire, including for example, incorrect inflation pressure, wheel caster angle, wheel camber angle, wheel toe angle, vehicle load distribution, running surface roughness, and the like. As a result, tires are often rotated (either via a change in tire position on the vehicle, a change in tire orientation (e.g., turning the tire around), or both) to allow tires to wear more evenly so as to increase service life of the tire and ultimately the safety associated with the use of the tire.

Measuring tire wear of a tire mounted on a vehicle, including wear of a ground-contacting portion, often requires the vehicle to be taken out of service for a period of time, while a technician measures the wear of the tire at one or more points on its ground-contacting portion.

What is needed is a tire wear indicator to allow one to quickly and simply check the overall wear and/or uneven wear of a tire.

### SUMMARY

In one embodiment, a tire having a tread is provided, comprising: a ground-contacting portion oriented at the radially outermost surface of the tire; at least one notch extending radially inward from the ground-contacting portion, wherein the at least one notch includes at least one notch sidewall and a notch base; at least one tire wear indicator extending from the at least one notch sidewall partially into the at least one notch; wherein the at least one tire wear indicator does not extend completely across the at least one notch; and wherein the at least one tire wear indicator does not directly contact the notch base.

In another embodiment, a tire having a tread is provided, comprising: a ground-contacting portion oriented at the radially outermost surface of the tire; at least one notch extending radially inward from the ground-contacting portion, wherein the at least one notch includes at least one notch sidewall and a notch base; a plurality of tire wear indicators extending from the at least one notch sidewall partially into the at least one notch; wherein the plurality of tire wear indicators is oriented in a circumferential position on the tire; wherein each of the plurality of tire wear indicators is oriented in a series of differing radial heights in the circumferential position; wherein the at least one tire wear indicator does not extend completely across the at least one notch; and wherein the at least one tire wear indicator does not directly contact the notch base.

In another embodiment, a tire having a tread is provided, comprising: a ground-contacting portion oriented at the radially outermost surface of the tire; at least one groove extending radially inward from the ground-contacting portion, wherein the at least one groove includes at least one groove sidewall and a groove base; at least one tire wear indicator extending from the at least one groove sidewall partially into the at least one groove; wherein the at least one tire wear indicator does not extend completely across the at least one groove; and wherein the at least one tire wear indicator does not directly contact the groove base.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates a perspective view of an example embodiment of a tire 100 having at least one tire wear indicator 108.

FIG. 2 illustrates a perspective view of an example embodiment of a tire 200 having at least one tire wear indicator 208.

FIG. 3 illustrates a partial view of an example embodiment of a tire 300 having at least one tire wear indicator 308.

FIG. 4 illustrates a partial elevational view of an example embodiment of a tire 400 having at least one tire wear indicator 408.

FIG. 5 illustrates a partial elevational view of an example embodiment of a tire 500 having at least one tire wear indicator 508.

FIG. 6 illustrates a partial elevational view of an example embodiment of a tire 600 having at least one tire wear indicator 608.

FIG. 7 illustrates a partial elevational view of an example embodiment of a tire 700 having at least one tire wear indicator 708.

FIG. 8 illustrates a partial plan view of an example embodiment of a tire 800 having at least one tire wear indicator 808.

FIG. 9 illustrates a partial plan view of an example embodiment of a tire 900 having at least one tire wear indicator 908.

FIG. 10 illustrates a partial plan view of an example embodiment of a tire 1000 having at least one tire wear indicator 1008.

FIG. 11 illustrates a partial plan view of an example embodiment of a tire 1100 having at least one tire wear indicator 1108.

FIG. 12A illustrates a partial elevational view of an example embodiment of a tire 1200 having at least one tire wear indicator 1208.

FIG. 12B illustrates a partial elevational view of an example embodiment of tire 1200 having at least one tire wear indicator 1208.

FIG. 13 illustrates a plan view of an example embodiment of a tire 1300 having at least one tire wear indicator 1308.

FIG. 14 illustrates a plan view of an example embodiment of at least one tire 1400 having at least one tire wear indicator 1408.

FIG. 15A illustrates a plan view of an example embodiment of at least one tire 1500 having at least one tire wear indicator 1508.

FIG. 15B illustrates a plan view of an example embodiment of at least one tire 1500 having at least one tire wear indicator 1508.

FIG. 16 illustrates a perspective view of an example embodiment of a tire mold element 1620 used in molding at least one tire wear indicator.

### DETAILED DESCRIPTION

Vehicle tires are often made up at least in part by a polymer material. The polymer material may include a rubber material. Vehicle tires often include a rubber ground-contacting portion. Vehicle tires may be pneumatic, non-pneumatic, or some hybrid of pneumatic and non-pneumatic in nature.

Vehicle tires may lack tread patterns found on common automobile tires, and as such, may be difficult to visually inspect for wear. For example, some off-the-road tires, including for example, port forklift trucks, mining tires, and the like, may have very large and very few tread blocks about the circumference of the ground-contacting portion. Alternatively, some off-the-road tires may include only one or two notches in an otherwise “slick” ground-contacting portion.

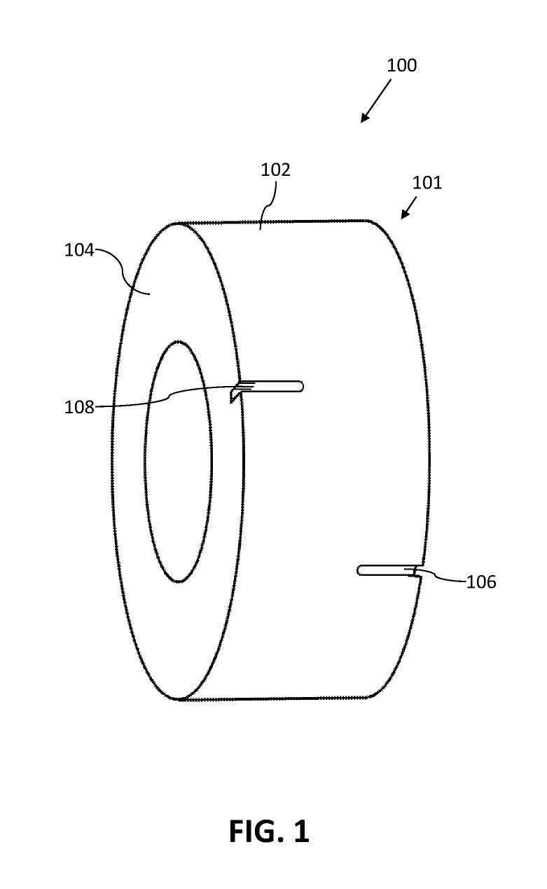

FIG. 1 illustrates a perspective view of an example embodiment of a tire 100 having at least one tire wear indicator 108. Tire 100 may include a tire tread 101. Tire 100 may include a ground-contacting portion 102. Ground-contacting portion 102 may be the radially outermost portion of tire 100. Tire 100 may include one or more sidewall 104. In one embodiment, tire 100 includes two sidewalls 104 oriented on either side of ground-contacting portion 102. Tire 100 may include at least one notch 106. At least one tire wear indicator 108 may be oriented in at least one notch 106.

In one embodiment, tire 100 includes a single notch 106. In another embodiment, tire 100 includes two notches 106. In another embodiment, tire 100 includes more than two notches 106. Tire 100 may include at least one notch 106 on each side of tire 100. For example, tire 100 includes a first axial side and a second axial side, and at least one notch 106 extends at least partially across the width of tire 100 from each axial side. Notch 106 may extend radially inward from ground-contacting portion 102.

In one embodiment, notch 106 extends completely across the width of ground-contact portion 102. In another embodiment, at least one notch 106 may extend about 40% across the width of ground-contact portion 102. In another embodiment, at least one notch 106 extends partially across the width of ground-contact portion 102.

Tire 100 may include tire tread 101, which is inclusive of ground-contact portion 102. Tread 101 may have a tread depth, or thickness, past which tire 100 cannot wear within its practical service life. Stated differently, tire 100 would be deemed to have surpassed its practical service life after wearing completely through its tread depth, and would thus be removed from service. In one embodiment, notch 106 has a depth that is substantially equal to the tread depth of tread 101. In another embodiment, notch 106 has a depth that is less than the tread depth of tread 101. In another embodiment, notch 106 has a depth that is greater than the tread depth of tread 101.

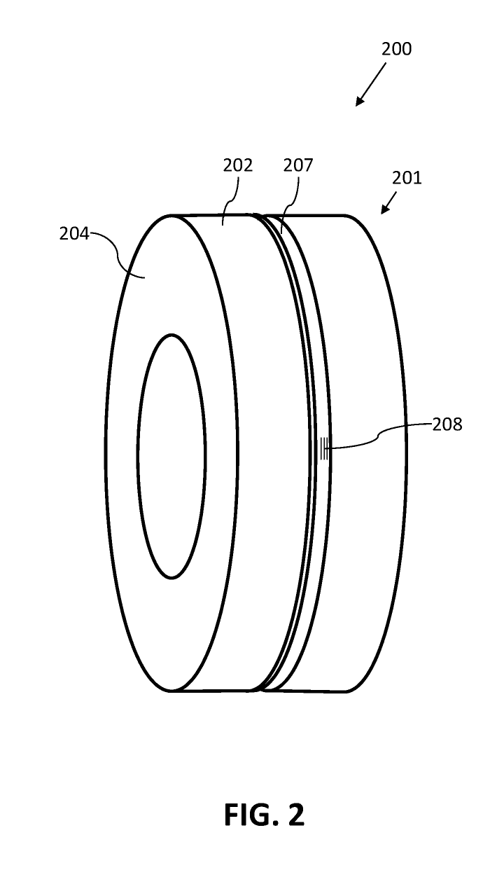

FIG. 2 illustrates a perspective view of an example embodiment of a tire 200 having at least one tire wear indicator 208. Tire 200 may include a tire tread 201. Tire 200 may include a ground-contacting portion 202. Tire 200 may include one or more sidewall 204. In one embodiment, tire 200 includes two sidewalls 204 oriented on either side of ground-contacting portion 202. Tire 200 may include at least one groove 206. At least one tire wear indicator 208 may be oriented in at least one groove 206.

Groove 206 may be a substantially circumferential groove. In addition, or in the alternative, tire 200 may include axial grooves (not shown), or grooves inclined relative to the central plane of the tire. Groove 206 may include a groove base and at least one groove sidewall. At least one tire wear indicator 208 may be oriented on a groove sidewall 207.

Tire 200 may include a series of grooves 206, forming a plurality of tread ribs (not shown) having sidewalls. At least one of the rib sidewalls may include at least one tire wear indicator 208.

Tire 200 may include a series of interconnected grooves (not shown), forming a plurality of tread blocks (not shown) having sidewalls. At least one of the tread block sidewalls may include at least one tire wear indicator 208.

Groove 206 may include at least one groove sidewall 207 and a groove base (not shown). Tire wear indicators 208 may extend from groove sidewall 207 partially into groove 206, but may not extend (i.e., bridge) completely across the width of groove 206. Tire wear indicators 208 may not directly contact notch base 209.

In one embodiment, tire 200 may include an agricultural tire with a common pattern of tread blocks or tread lugs having sidewalls oriented about its circumference. For example, tire 200 may be a drive tire for a tractor, loader, combine, irrigation system, or other piece of agricultural equipment. At least one of the tread block or tread lug sidewalls may include at least one tire wear indicator 208.

Tire 200 may include any of a variety of tires, including for example, an agricultural tire, an off-the-road equipment tire, a passenger tire, a truck tire, a bus tire, an ATV tire, a UTV tire, a motorcycle tire, an airplane tire, and the like.

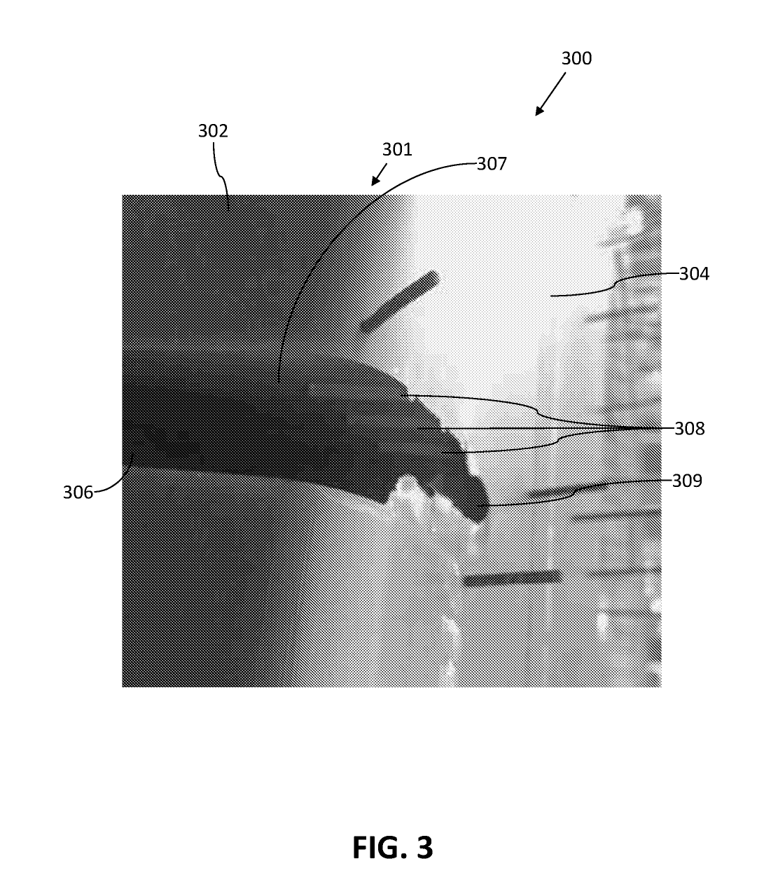

FIG. 3 illustrates a partial view of an example embodiment of a tire 300 having at least one tire wear indicator 308. Tire 300 may include a tire tread 301. Tire 300 may include a ground-contacting portion 302. Tire 300 may include one or more sidewall 304. Tire 300 may include at least one notch 306. At least one tire wear indicator 308 may be oriented in at least one notch 306.

Notch 306 may include a notch sidewall 307 that is substantially radially oriented. At least one tire wear indicator 308 may include a series of tire wear indicators 308. Each tire wear indicator 308 may include an element extending from notch sidewall 307 partially into notch 306. Alternatively, each tire wear indicator 308 may include an element extending into notch sidewall 307. Alternatively, tire wear indicators 308 may include some tire wear indicators 308 extending from notch sidewall 307, and some tire wear indicators 308 extending into notch sidewall 307. For example, every other tire wear indicator 308 in a series of tire wear indicators 308 may extending into notch sidewall 307, while the remaining tire wear indicators 308 may extend out of notch sidewall 307. Notch 306 may include a notch base 309.

Tire wear indicators 308 may extend from notch sidewall 307 partially into notch 306, but may not extend (i.e., bridge) completely across the width of notch 306. Tire wear indicators 308 may not directly contact notch base 309. At least one tire wear indicator 308 may include a plurality of tire wear indicators oriented at a circumferential position on the tire and oriented in a radially spaced series.

At least one tire wear indicator 308 may include a substantially axially-aligned elongated element (e.g., a ridge) extending from notch sidewall 307.

Alternatively, at least one tire wear indicator 308 may include a substantially circular “bump” extending from notch sidewall 307. At least one tire wear indicator 308 may include any of a variety of shapes and cross-sections, including for example, a circle, a semicircle, a square, a rectangle, a triangle, a groove, a ridge, a regular shape, an irregular shape, and the like.

At least one tire wear indicator 308 may be visually observed by a user of tire 300, such that the user can confirm how many tire wear indicators are visible on notch sidewall 307, which informs the user approximately how much tread depth of tread 301 is remaining in tire 300, and thus how much service life is left in tire 300.

At least one tire wear indicator 308 may be tactilely observed by a user of tire 300, such that the user can feel at least one tire wear indicator 308 (or note the absence of at least one tire wear indicator 308) and confirm how many tire wear indicators are visible on notch sidewall 307, which informs the user approximately how much tread depth of tread 301 is remaining in tire 300, and thus how much service life is left in tire 300.

In one embodiment, tire 300 includes two notches 306, wherein one notch 306 is oriented on a first side of tire 300, and wherein another notch 306 is oriented on a second side of tire 300. A user may compare the number of tread wear indicators 308 remaining in a first notch 306 to the number of tread wear indicators 308 remaining in a second notch 306. Wherein the number of tread wear indicators 308 in the first and second notch 306 are different, tire 300 may be wearing unevenly. Wherein the number of tread wear indicators 308 in the first and second notch 306 are the same, tire 300 may be wearing evenly.

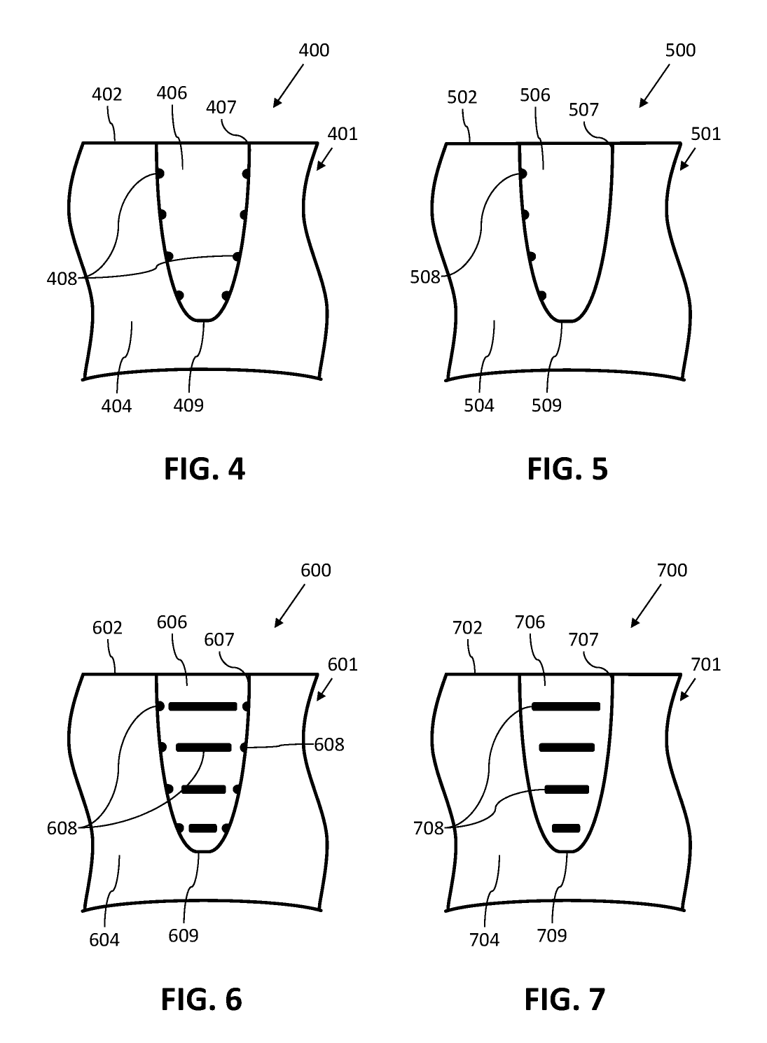

FIG. 4 illustrates a partial elevational view of an example embodiment of a tire 400 having at least one tire wear indicator 408. Tire 400 may include a tire tread 401. Tire 400 may include a ground-contacting portion 402. Tire 400 may include one or more sidewall 404. Tire 400 may include at least one notch 406. At least one tire wear indicator 408 may be oriented in at least one notch 406. Notch 406 may include at least one notch sidewall 407 from which at least one tire wear indicator 408 may extend. Notch 406 may include a notch base 409.

As illustrated, a series of tire wear indicators 408 may extend along two notch sidewall 407 at varying radial heights. As such, a user can observe (visually or tactilely) the number of tire wear indicators 408 remaining in notch 406 from various angles relative to the tire wear indicators 408.

FIG. 5 illustrates a partial elevational view of an example embodiment of a tire 500 having at least one tire wear indicator 508. Tire 500 may include a tire tread 501. Tire 500 may include a ground-contacting portion 502. Tire 500 may include one or more sidewall 504. Tire 500 may include at least one notch 506. At least one tire wear indicator 508 may be oriented in at least one notch 506. Notch 506 may include at least one notch sidewall 507 from which at least one tire wear indicator 508 may extend. Notch 506 may include a notch base 509.

As illustrated, a series of tire wear indicators 508 may extend along one notch sidewall 507 at varying radial heights. As such, a user can observe (visually or tactilely) the number of tire wear indicators 508 remaining in notch 506.

FIG. 6 illustrates a partial elevational view of an example embodiment of a tire 600 having at least one tire wear indicator 608. Tire 600 may include a tire tread 601. Tire 600 may include a ground-contacting portion 602. Tire 600 may include one or more sidewall 604. Tire 600 may include at least one notch 606. At least one tire wear indicator 608 may be oriented in at least one notch 606. Notch 606 may include at least one notch sidewall 607 from which at least one tire wear indicator 608 may extend. Notch 606 may include a notch base 609.

As illustrated, a series of tire wear indicators 608 may extend along various notch sidewalls 607 at varying radial heights. As such, a user can observe (visually or tactilely) the number of tire wear indicators 608 remaining in notch 606 from various positions relative to wear tire wear indicators 608.

FIG. 7 illustrates a partial elevational view of an example embodiment of a tire 700 having at least one tire wear indicator 708. Tire 700 may include a tire tread 701. Tire 700 may include a ground-contacting portion 702. Tire 700 may include one or more sidewall 704. Tire 700 may include at least one notch 706. At least one tire wear indicator 708 may be oriented in at least one notch 706. Notch 706 may include at least one notch sidewall 707 from which at least one tire wear indicator 708 may extend. Notch 706 may include a notch base 709.

As illustrated, a series of tire wear indicators 708 may extend along one notch sidewall 707 at varying radial heights. As such, a user can observe (visually or tactilely) the number of tire wear indicators 708 remaining in notch 706. At least one tire wear indicator 708 may extend from the axially-innermost notch sidewall 707.

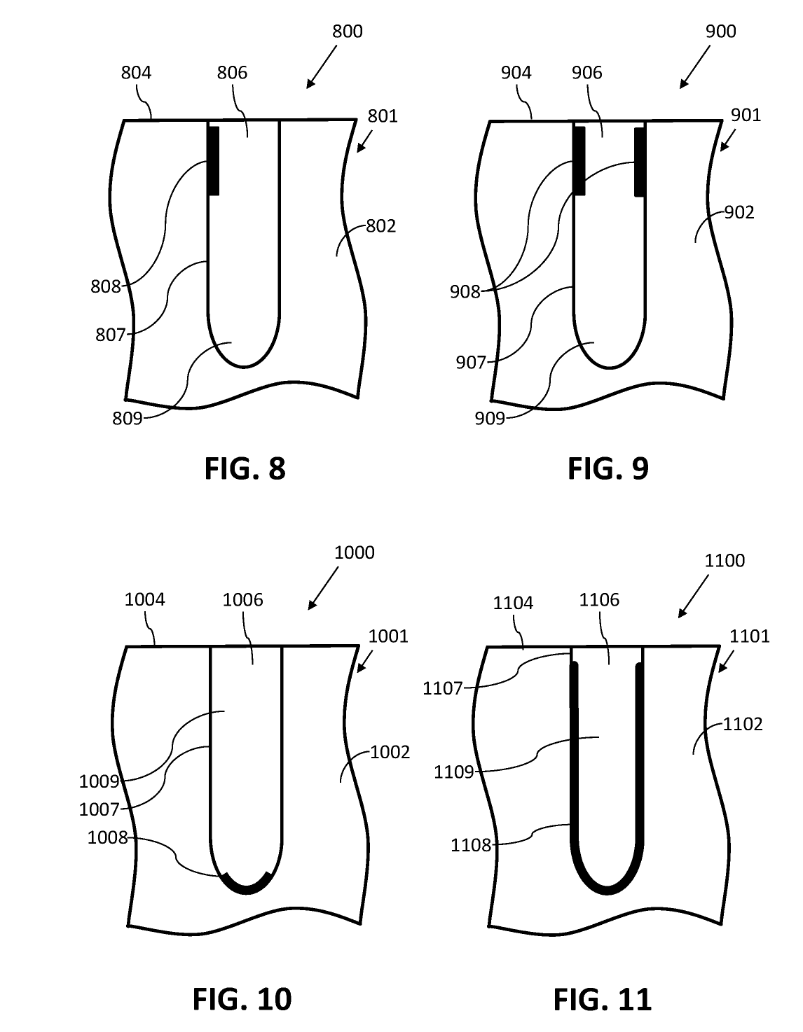

FIG. 8 illustrates a partial plan view of an example embodiment of a tire 800 having at least one tire wear indicator 808. Tire 800 may include a tire tread 801. Tire 800 may include a ground-contacting portion 802. Tire 800 may include at least one notch 806. At least one tire wear indicator 808 may be oriented in at least one notch 806. Notch 806 may include at least one notch sidewall 807 from which at least one tire wear indicator 808 may extend. Notch 806 may include a notch base 809.

As illustrated, at least one tire wear indicator 808 may be oriented so as to extend partially along one of notch sidewalls 807. At least one tire wear indicator 808 may extend from an axially-outermost portion of notch sidewall 807.

FIG. 9 illustrates a partial plan view of an example embodiment of a tire 900 having at least one tire wear indicator 908. Tire 900 may include a tire tread 901. Tire 900 may include a ground-contacting portion 902. Tire 900 may include at least one notch 906. At least one tire wear indicator 908 may be oriented in at least one notch 906. Notch 906 may include at least one notch sidewall 907 from which at least one tire wear indicator 908 may extend. Notch 906 may include a notch base 909.

As illustrated, at least one tire wear indicator 908 may be oriented so as to extend partially along two of notch sidewalls 907. At least one tire wear indicator 908 may extend from an axially-outermost portion of notch sidewall 907.

FIG. 10 illustrates a partial plan view of an example embodiment of a tire 1000 having at least one tire wear indicator 1008. Tire 1000 may include a tire tread 1001. Tire 1000 may include a ground-contacting portion 1002. Tire 1000 may include at least one notch 1006. At least one tire wear indicator 1008 may be oriented in at least one notch 1006. Notch 1006 may include at least one notch sidewall 1007 from which at least one tire wear indicator 1008 may extend. Notch 1006 may include a notch base 1009.

As illustrated, at least one tire wear indicator 1008 may be oriented so as to extend partially along one of notch sidewalls 1007. Tire wear indicator 1008 may be oriented to extend from an axially inner notch sidewall 1007 to permit viewing of tire wear indicator 1008 from the side of tire 1000, the top of tire 1000, and the like.

FIG. 11 illustrates a partial plan view of an example embodiment of a tire 1100 having at least one tire wear indicator 1108. Tire 1100 may include a tire tread 1101. Tire 1100 may include a ground-contacting portion 1102. Tire 1100 may include at least one notch 1106. At least one tire wear indicator 1108 may be oriented in at least one notch 1106. Notch 1106 may include at least one notch sidewall 1107 from which at least one tire wear indicator 1108 may extend. Notch 1106 may include a notch base 1109.

As illustrated, at least one tire wear indicator 1108 may be oriented so as to extend partially along one of notch sidewalls 1107. Tire wear indicator 1108 may be oriented to extend from an axially inner notch sidewall 1107 to permit viewing of tire wear indicator 1108 from various angles relative to tire wear indicator 1108.

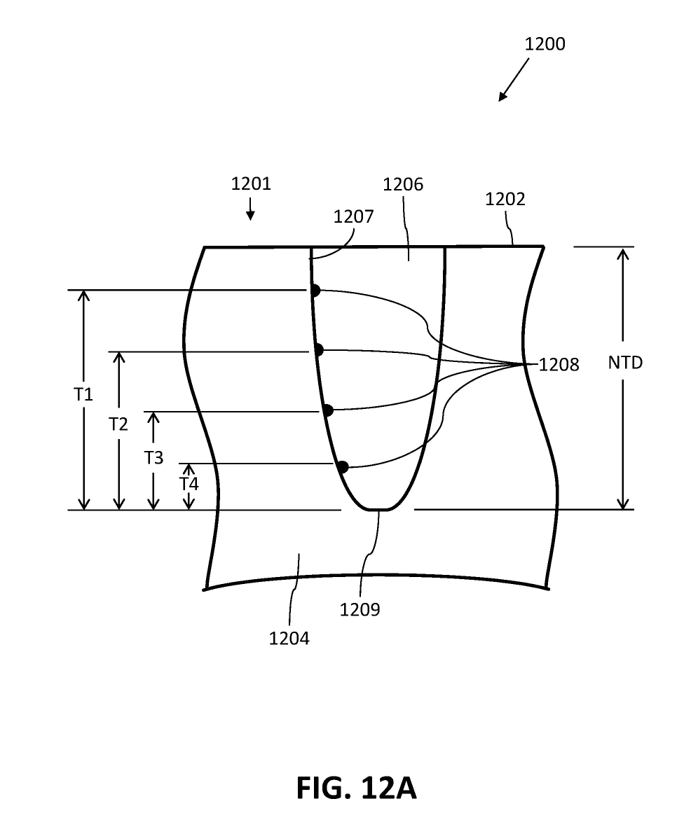

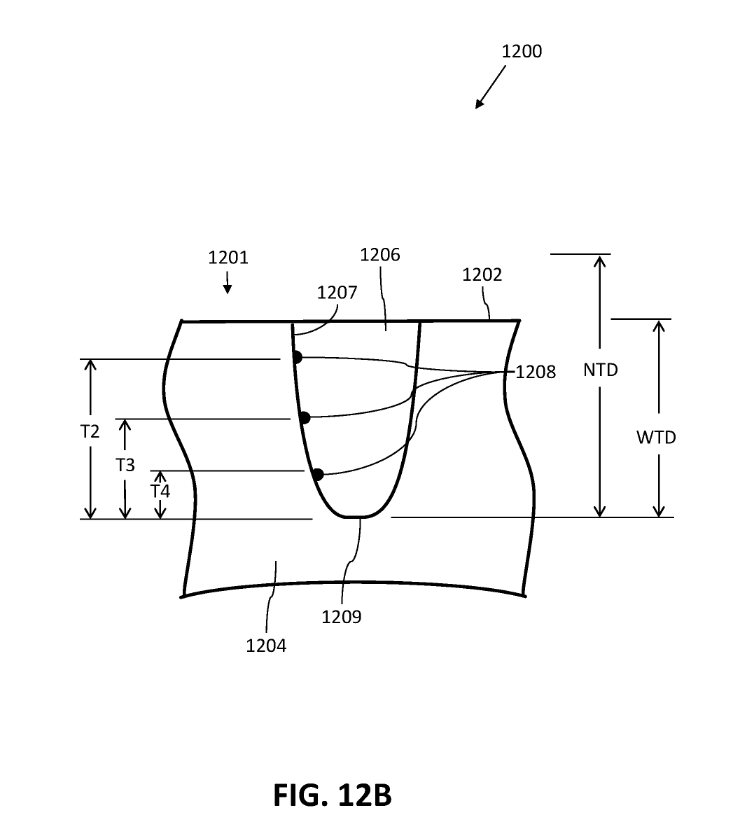

FIGS. 12A and 12B illustrate partial elevational views of an example embodiment of a tire 1200 having at least one tire wear indicator 1208. Tire 1200 may include a tire tread 1201. Tire 1200 may include a ground-contacting portion 1202. Tire 1200 may include one or more sidewall 1204. Tire 1200 may include at least one notch 1206. At least one tire wear indicator 1208 may be oriented in at least one notch 1206. Notch 1206 may include at least one notch sidewall 1207 from which at least one tire wear indicator 1208 may extend. Notch 1206 may include a notch base 1209.

As illustrated, a series of tire wear indicators 1208 may extend along notch sidewall 1207 at varying radial heights. The series of tire wear indicators 1208 may be oriented at a circumferential position on tire 1200. Notch 1206 may have a radial height equal to a new tread depth NTD. A plurality of tire wear indicators 1208 may be oriented in a series at differing radial heights corresponding to different radial thicknesses. That is, a radially outermost tire wear indicator 1208 may be oriented at thickness T1. Radially below another tire wear indicator 1208 may be oriented at thickness T2, with another at thickness T3 oriented therebelow. Finally, the radially innermost tire wear indicator 1208 may have oriented at a thickness T4. It is understood that tire 1200 may include any number of tire wear indicators 1208.

As illustrated in FIG. 12A, tire 1200 includes a new tread depth NTD. As illustrated in FIG. 12B, a portion of tread 1201 has been worn away, for example through use of the tire. As illustrated in FIG. 12B, tire 1200 includes a worn tread depth WTD, and the tire wear indicator 1208 oriented at thickness T1 has been worn away with tread 1201.

The radial distance between tire wear indicators 1208 may be a set distance, and is known by the individual(s) responsible for checking tire wear. In this manner, a user can visually or tactilely identify the number of remaining tire wear indicators 1208 on notch sidewall 1207, and thus know approximately how much tread depth remains in tire 1200. As such, a user can estimate approximately how much service life remains in tire 1200. Likewise, a user can compare the number of tread wear indicators 1208 on a first side of tire 1200 to the number of tread wear indicators 1208 on a second side of tire 1200, and thus identify an uneven wear situation.

The radial distance between tire wear indicators 1208 may be any of a variety of distances. The radial distance between tire wear indicators 1208 may be about 12.7 mm (0.5 in.). The radial distance between tire wear indicators 1208 may be 12.7 mm (0.5 in.). The radial distance between tire wear indicators 1208 may be between about 2.5 mm (0.1 in.) and about 25.4 mm (1.0 in.). The radial distance between tire wear indicators 1208 may be between 2.5 mm (0.1 in.) and 25.4 mm (1.0 in.). The radial distance between tire wear indicators 1208 may be between about 7.6 mm (0.3 in.) and about 17.8 mm (0.7 in.). The radial distance between tire wear indicators 1208 may be between 7.6 mm (0.3 in.) and 17.8 mm (0.7 in.).

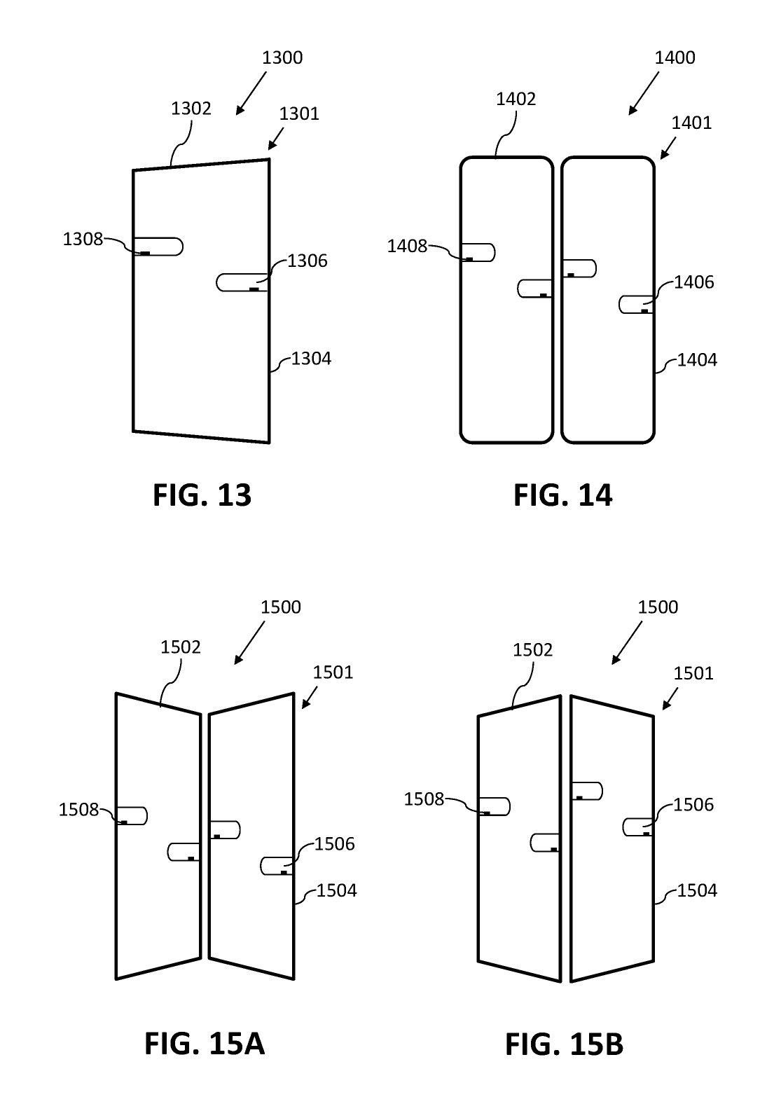

FIG. 13 illustrates a plan view of an example embodiment of a tire 1300 having at least one tire wear indicator 1308. Tire 1300 may include a tire tread 1301. Tire 1300 may include a ground-contacting portion 1302. Tire 1300 may include one or more sidewall 1304. Tire 1300 may include at least one notch 1306. At least one tire wear indicator 1308 may be oriented in at least one notch 1306.

Tire 1300 may exhibit uneven wear, such that the worn depth of tread 1301 on a first side of tire 1300 is less than the worn depth of tread 1301 on a second side of tire 1300. A user may observe uneven wear in tire 1300 by comparing the number of tread wear indicators 1308 remaining in notch 1306 on a first side of tire 1300 to the number of tread wear indicators 1308 remaining in notch 1306 on a second side of tire 1300. For example, two tread wear indicators 1308 may remain in notch 1306 on a first side of tire 1300, while three tread wear indicators 1308 may remain in notch 1306 on a second side of tire 1300. A user may easily know to rotate, reposition, modify the alignment of, or otherwise address the uneven wear of tire 1300 before the wear becomes so uneven as to cut short the service life of tire 1300 or cause a safety concern in the use of tire 1300.

FIG. 14 illustrates a plan view of an example embodiment of at least one tire 1400 having at least one tire wear indicator 1408. Each tire 1400 may include a tire tread 1401. Tires 1400 may include a ground-contacting portion 1402. Tires 1400 may include one or more sidewall 1404. Tires 1400 may include at least one notch 1406. At least one tire wear indicator 1408 may be oriented in at least one notch 1406.

Tires 1400 may be oriented as dual tires, such that each tire 1400 is mounted on a wheel adjacent to the other to form a dual tire and wheel assembly.

FIGS. 15A and 15B illustrate a plan view of an example embodiment of at least one tire 1500 having at least one tire wear indicator 1508. Each tire 1500 may include a tire tread 1501. Tires 1500 may include a ground-contacting portion 1502. Tires 1500 may include one or more sidewall 1504. Tires 1500 may include at least one notch 1506. At least one tire wear indicator 1508 may be oriented in at least one notch 1506.

In some applications of tires 1500, extreme loading may cause dual tire and wheel assemblies to wear unevenly between the two tires 1500. That is, the worn depth of treads 1501 on the sides of tires 1500 that are adjacent to one another may be less than the worn depth of treads 1501 on the sides of tires 1500 that are oriented away from one another. As such, when the dual tire and wheel assembly is mounted on a vehicle, it may appear from the outboard side of the vehicle that the dual tire and wheel assembly is not wearing unevenly. However, the use of at least one wear indicator 1508 in notches 1506 may allow one to readily discern by inspecting tires 1500 (visually or tactilely) radially outward of the dual tire and wheel assembly that uneven wear is occurring.

As illustrated in FIG. 15B, tires 1500 may wear unevenly in the opposite manner as is illustrated in FIG. 15A. However, the use of at least one wear indicator 1508 in notches 1506 may allow one to readily discern by inspecting tires 1500 (visually or tactilely) radially outward of the dual tire and wheel assembly that uneven wear is occurring.

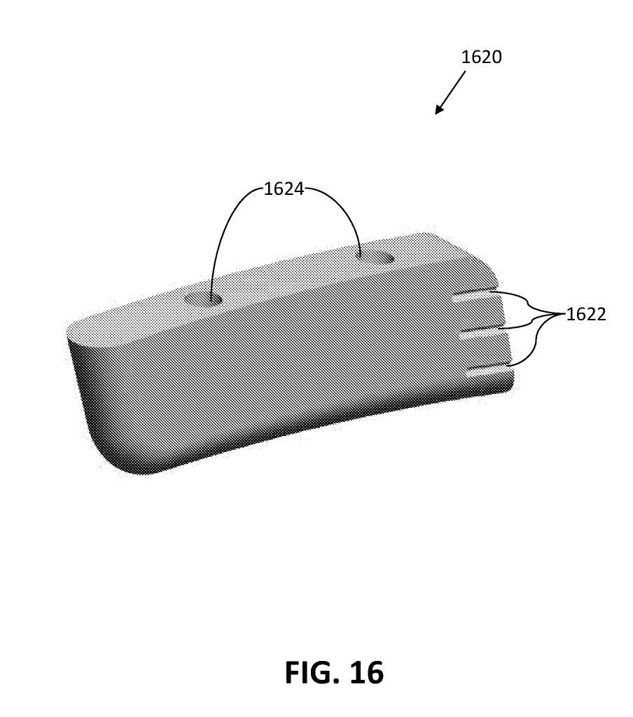

FIG. 16 illustrates a perspective view of an example embodiment of a tire mold element 1620 used in molding at least one tire wear indicator. Mold element 1620 may include at least one tire wear indicator molding feature 1622, which may be a negative of the desired tire wear indicator (not shown) to be molded into a tire. Mold element 1620 may be integrally connected to, or bolted into, a tire mold. Mold element 1620 may include bolt apertures 1624 which may permit a user to selectively attach mold element 1620 to a mold.

In one embodiment, any of the tires illustrated in FIG. 1 and FIGS. 3-15B may be manufactured using a press mold. As such, any tire wear indicator oriented along the axial direction of the tire, or extending from the tire in the axial direction, may be oriented in the “release direction” of the press mold, and thus may be less likely to tear during removal of the tire from the tire mold.

In one embodiment, any of the tires illustrated and described herein may be manufactured using a pot heater. As such, any tire wear indicator oriented along the axial direction of the tire, or extending from the tire in the axial direction, may be oriented in the “release direction” of the tire mold in the pot heater, and thus may be less likely to tear during removal of the tire from the tire mold.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire having a tire tread, comprising:
a ground-contacting portion oriented at the radially outermost surface of the tire;
at least one notch extending radially inward from the ground-contacting portion,
wherein the at least one notch includes at least one notch sidewall and a notch base;
at least one tire wear indicator extending from the at least one notch sidewall partially into the at least one notch;
wherein the at least one tire wear indicator does not extend completely across the at least one notch; and
wherein the at least one tire wear indicator does not directly contact the notch base.

2. The tire of claim 1, wherein the at least one tire wear indicator includes a plurality of tire wear indicators.

3. The tire of claim 2, wherein the plurality of tire wear indicators is oriented in a circumferential position on the tire.

4. The tire of claim 3, wherein each of the plurality of tire wear indicators is oriented in a series of differing radial heights in the circumferential position.

5. The tire of claim 1, wherein the at least one tire wear indicator is an axially-aligned elongated element.

6. The tire of claim 1, wherein the at least one tire wear indicator extends from an axially-innermost portion of the notch sidewall.

7. The tire of claim 1, wherein the at least one tire wear indicator extends from an axially-outermost portion of the notch sidewall.

8. The tire of claim 2, wherein the plurality of tire wear indicators extend from both an axially-innermost portion of the notch sidewall, and an axially-outermost portion of the notch sidewall.

9. The tire of claim 4, wherein a radial distance between adjacent tire wear indicators is about 12.7 mm.

10. The tire of claim 4, wherein a radial distance between adjacent tire wear indicators is between about 2.5 mm and about 25.4 mm.

11. The tire of claim 4, wherein a radial distance between adjacent tire wear indicators is between about 7.6 mm and about 17.8 mm.

12. A tire having a tire tread, comprising:
a ground-contacting portion oriented at the radially outermost surface of the tire;
at least one notch extending radially inward from the ground-contacting portion,
wherein the at least one notch includes at least one notch sidewall and a notch base;
a plurality of tire wear indicators extending from the at least one notch sidewall partially into the at least one notch;
wherein the plurality of tire wear indicators is oriented in a circumferential position on the tire;
wherein each of the plurality of tire wear indicators is oriented in a series of differing radial heights in the circumferential position;
wherein the at least one tire wear indicator does not extend completely across the at least one notch; and
wherein the at least one tire wear indicator does not directly contact the notch base.

13. The tire of claim 12, wherein the plurality of tire wear indicators are axially-aligned elongated elements.

14. The tire of claim 12, wherein the plurality of tire wear indicators extend from an axially-innermost portion of the notch sidewall.

15. The tire of claim 12, wherein the plurality of tire wear indicators extend from an axially-outermost portion of the notch sidewall.

16. The tire of claim 12, wherein the plurality of tire wear indicators extend from both an axially-innermost portion of the notch sidewall, and an axially-outermost portion of the notch sidewall.

17. The tire of claim 12, wherein a radial distance between adjacent tire wear indicators is about 12.7 mm.

18. The tire of claim 12, wherein a radial distance between adjacent tire wear indicators is between about 2.5 mm and about 25.4 mm.

19. The tire of claim 12, wherein a radial distance between adjacent tire wear indicators is between about 7.6 mm and about 17.8 mm.

20. A tire having a tire tread, comprising:
a ground-contacting portion oriented at the radially outermost surface of the tire;
at least one groove extending radially inward from the ground-contacting portion,
wherein the at least one groove includes at least one groove sidewall and a groove base;
at least one tire wear indicator extending from the at least one groove sidewall partially into the at least one groove;
wherein the at least one tire wear indicator does not extend completely across the at least one groove; and
wherein the at least one tire wear indicator does not directly contact the groove base.
